(19) United States
(12) Patent Application Publication
(10) Pub. No.: US 2015/0304629 A1
(43) Pub. Date: Oct. 22, 2015

(54) SYSTEM AND METHOD FOR STEREOPHOTOGRAMMETRY

(71) Applicants: XIUCHUAN ZHANG, West Vancouver (CA); JINGYI ZHANG, Edmonton (CA)

(72) Inventors: XIUCHUAN ZHANG, West Vancouver (CA); JINGYI ZHANG, Edmonton (CA)

(21) Appl. No.: 14/257,331

(22) Filed: Apr. 21, 2014

(51) Int. Cl. H04N 13/02

(52) U.S. Cl. CPC H04N 13/02

(57) ABSTRACT

The invention is directed to a stereophotogrammetric system and method for generating 3D images. A stereophotogrammetric unit, having a plurality of cameras, is structured to capture a set of images of an object at different angles. A controller is communicably connected to the stereophotogrammetric unit, and is configured to facilitate the simultaneous triggering of the plurality of cameras through a synchronized trigger signal, such that the cameras will capture respective images of the object at the same time. A processing module is configured to generate 3D image from the set of images captured. The controller may further be configured to facilitate the sequential triggering of a plurality of stereophotogrammetric units, such that the object in motion may be captured at increased frames per second. The processing module may further be configured to link together the plurality of 3D images in sequence to then create a 4D image.

### BACKGROUND OF THE INVENTION

1. Field of the Invention

The present invention generally relates to a system and method for stereophotogrammetry, wherein objects are captured and 3D and 4D images of the objects are then generated. Specifically, a stereophotogrammetric unit comprising a plurality of cameras is calibrated to activate with various delays, such that the 2D image captures of an object at different angles are synchronized across the plurality of cameras, thus resulting in a consistent and higher quality 3D image. Further, a plurality of stereophotogrammetric units may be triggered in sequence at predetermined time intervals to increase the frame rate of capture, which results in a higher quality 4D image.

2. Description of the Related Art

Stereophotogrammetry generally refers to the calculation of height or depth dimensions of an object by contrasting at least two overlapping images taken from different angles. By using the geometry based on the intersection of at least two rays created from their respective image's point of view, it is then possible to calculate the appropriate depth or height values of an overlapping image area. Accordingly, stereophotogrammetry allows for the accurate three-dimensional (3D) modeling of an object and for the creation of a 3D image of an object of capture. Furthermore, a four-dimensional (4D) image, i.e. a 3D animation, may be generated by linking together multiple 3D images captured in sequence.

Accordingly, 3D and 4D stereophotogrammetry scanning have a wide range of applications, such as high definition full body scanning for medical diagnostic purposes, or the scanning of human facial expressions or various objects in motion for gaming and animation studios. The number of cameras required will vary depending on the object of capture and the resolution or detail required.

Current stereogrammetry systems comprising commercial DSLR cameras are generally only capable of capturing a 3D model at less than 5 frames per second. A main contributor to this limitation is the activation lag difference (ALD) between the cameras. The ALD may result in image desynchronization during capture, making it difficult for any 3D modeling and/or recording software to compare the different images to locate key pixels, thus resulting in a poor or inconsistent 3D image. Another contributor is the technical limitation of available commercial cameras, which may only be able to shoot at are predetermined number of frames per second. As a result, the resulting 4D image generated may also be low or choppy due to the sparse number of frames captured per second.

Thus, there is a need for an improved stereophotogrammetric system which ensures that the underlying set of images used for 3D modeling is synchronously captured. Further, there is a need for an improved stereophotogrammetric system which can increase the frame rate of capture of the sets of images, to provide more frames per second upon playback and thereby ensuring a smoother 4D image.

### SUMMARY OF THE INVENTION

The present invention is generally directed to a system and method for stereophotogrammetry by synchronizing and coordinating the activation of groups of cameras sequentially, in order to reduce the activation lag difference (ALD) between each group of cameras to create a consistent 3D image, and to increase the frames rate of capture of 3D images.

Accordingly, by leveraging a controller to synchronize each group of cameras or each stereophotogrammetric unit to trigger at the same time, ALD between cameras can be drastically minimized. This results in a synchronized set of images for the generation of a 3D model. Further, by utilizing multiple groups of cameras or stereophotogrammetric units to activate in sequence, throughput of capture can be increased to capture and record more frames per second. This results in a smoother 4D image of the object of capture.

In initially broad terms, a system of the present invention may comprise at least one stereophotogrammetric unit communicably connected to a controller. A processing module may further be connected to the controller and/or to the at least one stereophotogrammetric unit.

Each stereophotogrammetric unit may comprise a plurality of cameras structured and disposed in spaced-apart relation, in order to capture a set of images of an object at different and appropriate angles, such that a 3D model may be constructed from the set of images. The number of cameras will depend on the application and resolution required. The cameras may comprise any device capable of capturing an object, but preferable commercial digital single-lens reflex cameras (DSLRs).

In order to generate an accurate 3D model of an object of capture based on a set of images captured by a stereophotogrammetric unit, each of the plurality of cameras of a stereophotogrammetric unit are synchronized to capture an object at the same time or very close to the same time. In dynamic scanning environments, i.e. face scanning with eyes blinking, a set of images having the same capture time will yield a more realistic and higher quality 3D image. In order to synchronize the capture of an object across a plurality of cameras of each stereophotogrammetric unit, a controller is implemented.

The controller may comprise a processing unit such as a microprocessor, or other integrated circuits appropriate for synchronizing the triggering of a plurality of cameras. The controller may be connected to the cameras directly, or by way of a shutter release device, either by wired or wireless connection. The controller may be programmed to transmit a synchronized trigger signal to each stereophotogrammetric unit, to ensure simultaneous capture of an object by its cameras. The synchronized trigger signal may comprise individual camera trigger signals for each camera, wherein some of the camera trigger signals are delayed, such that all cameras will capture an object at the same time.

The controller may further be configured to calculate how long each camera signal should be delayed through a calibration process. Accordingly, the activation lag delay of each camera may first be calculated, and the cameras are then delayed to trigger at the time of the camera with the longest activation lag delay. In other embodiments, activation lag delay may also be manually calculated and inputted.

After a set of images is captured by a stereophotogrammetric unit, a processing module may then generate a 3D image from the set of images. The processing module may comprise specialized or general purpose computers comprising appropriate software. The software may calculate the location of each pixel in 3D space by comparing the locations of common pixels across the set of images. A point cloud may then be generated after the pixels are analyzed. Depth dimensions may then calculated and a 3D rendering is generated.

In further embodiments, the controller may additionally be configured to effect the sequential and alternating triggering of a plurality of stereophotogrammetric units. This results in a higher frame rate of capture of an object in motion, and overcomes the technical limitation or rate of capture of individual stereophotogrammetric units. In such embodiments, the controller may be configured to facilitate the sequential and alternating triggering of a plurality of stereophotogrammetric units. Each stereophotogrammetric unit may be calibrated such as to effect the capture of an image at the same time through its plurality of cameras. The processing module may generate a 3D image for each time interval or set of images, and may further be configured to link together the resulting 3D images to form a 4D image.

These and other objects, features and advantages of the present invention will become clearer when the drawings as well as the detailed description are taken into consideration.

### BRIEF DESCRIPTION OF THE DRAWINGS

For a fuller understanding of the nature of the present invention, reference should be had to the following detailed description taken in connection with the accompanying drawings in which:

FIG. 1 is a diagrammatic representation of a system for stereophotogrammetry comprising a plurality of stereophotogrammetric units.

FIG. 2 depicts an example of a single stereophotogrammetric unit comprising two cameras.

FIG. 3 depicts an example illustrating the image capture rate of the stereophotogrammetric unit of FIG. 2.

FIG. 4 depicts an example of two stereophotogrammetric units each comprising two cameras.

FIG. 5 depicts an example illustrating the image capture rate of the stereophotogrammetric units of FIG. 4.

FIG. 6 is a process diagram illustrating a method for stereophotogrammetry.

FIG. 7 is a process diagram illustrating another method for stereophotogrammetry

Like reference numerals refer to like parts throughout the several views of the drawings.

### DETAILED DESCRIPTION OF THE PREFERRED EMBODIMENT

As illustrated by the accompanying drawings, the present invention is directed to a stereophotogrammetric system and method for capturing three-dimensional objects.

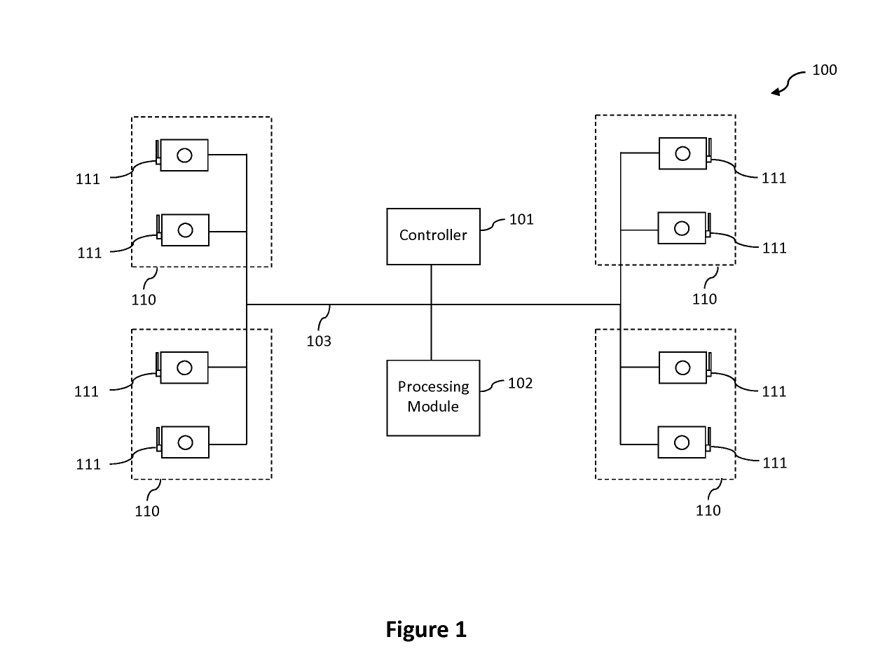

Accordingly, as illustrated in FIG. 1, a system 100 may comprise at least one stereophotogrammetric unit 110 communicably connected to a controller 101. A processing module 102 may further be connected to the controller 101 and/or to the at least one stereophotogrammetric unit 110.

Each stereophotogrammetric unit 110 comprises a plurality of cameras 111 structured and disposed in spaced-apart relation, such as to capture a set of images of an object at appropriate different angles. The illustrations show two cameras 111 for illustrative purposes, but it should be understood that in various embodiments, three or more cameras may be used at different angles to capture a larger set of images of an object at different angles. For example, full body scan may require around a hundred cameras, whereas a simple object may only require two cameras.

The cameras 111 may comprise any device capable of capturing an image of an object. Accordingly, the cameras 111 may comprise a lens and imager structured to capture light from the object and onto a storage medium such as film, flash memory, a magnetic hard disk, solid state drive, random access memory, or other storage device. The lens may comprise normal, wide-angle, focus, or any other lenses of various construction and materials known to those skilled in the art. The imager may comprise analog or digital image sensors, such as charge-coupled devices (CCD) image sensors, or complementary metal-oxide-semiconductor (CMOS) image sensors, or other imager, image sensor, or equivalents known to those skilled in the art. For example, the cameras 111 may, in a preferred embodiment, comprise commercial digital single-lens reflex cameras (DSLRs). However, in other embodiments, point-and-shoots, mobile devices such as phone or tablet cameras, wearable electronics, or other embedded cameras may be used, when quality is not a major concern.

In order to obtain an accurate 3D model of the object of capture, the images taken from the plurality of cameras 111 of each stereophotogrammetric unit 110 should capture the object at the same time. For objects in motion moving at high speeds, a difference in shutter speed of a few milliseconds or even microseconds may result in an inaccurate correlation between the set of images. To ensure synchronization of image capture for each set of images, a controller 101 is implemented to facilitate the simultaneous triggering of the plurality of cameras 111, which minimizes the activation lag difference between the cameras 111 of each stereophotogrammetric unit 110.

Accordingly, the controller 101 may comprise a processing unit such as a microprocessor or other integrated circuits structured and configured to synchronize the triggering of the plurality of cameras 111 of each stereophotogrammetric unit 110. In at least one embodiment, a controller 101 may be connected each camera 111 of each stereophotogrammetric unit 110 directly, to effect the triggering of each camera 111. In other embodiments, shutter release devices may be used in connection with controller 101 and cameras 111, and may be connected to the controller 101 and/or cameras 111 by wired or wireless connection to effect the triggering of the cameras 111. Wired or wireless connections may comprise standard shutter release cables, USB, Ethernet, CAT5, WiFi, infrared, radio, NFC, or other connections known to those skilled in the art and appropriate for the remote triggering of cameras.

Controller 101 may be programmed to transmit a synchronized trigger signal to each stereophotogrammetric unit 110, to ensure simultaneous capture of an object by the plurality of cameras 111. The synchronized trigger signal may comprise a plurality of camera trigger signals, wherein each given camera signal is directed to the triggering of a given camera 111 of a stereophotogrammetric unit 110. The triggering of at last one camera 111 may be delayed, via a delayed camera signal, such that all cameras 111 will trigger at a moment in time, such as to capture an object at the same time.

In order to calculate how long each camera signal must be delayed to effect the capture of an image at the same time across the plurality of cameras 111, the activation lag delay for each camera 111 of a stereophotogrammetric unit 110 must be calculated. The activation lag delay takes in account of different shutter speeds, response times, delay between image captures, and/or other technical limitations of the cameras 111.

In at least one embodiment, the activation lag delay of each camera 111 may be calculated by a calibration process. In such an embodiment, a plurality of cameras 111 may be placed in spaced apart relation to capture an object at different angles, such as to capture a set of images of the object in order to create a 3D model. The object may be a cylinder with thin lines and identifying numbers or other identifying indicia. The space between two adjacent lines may be 1 mm. The cylinder is rotatably driven by a constant speed motor, and effects a constant line speed of x mm/ms (for example 1 mm/ms), two images of the rotating surface of the cylinder is then take with each camera at a high shutter speed (over 1/2000s for example). From the line identifying number of the two images, the activation lag delay between the two cameras can be derived. For example, if the first camera is ahead of the second camera for 20 mm based on the given speed and example, the activation lag difference between the two cameras would be 20 mm divided by 1 mm/ms=20 ms. The slower camera would then be artificially delayed by 20 ms, so the resulting capture of the image from the cameras would occur at the same time.

In some embodiments, the activation lag delay may be manually calculated and configured. In other embodiments, the calibration process may be built into the controller 101 which may at least partially automatically calibrate the cameras 111 of each stereophotogrammetric unit 110 and set the delays of the cameras 111 accordingly.

After a set of images is captured by a stereophotogrammetric unit 110. A processing module 102 may then generate a 3D image from the set of images. Each set of images refers to images taken by a plurality of cameras 111 at the same time, “same time” as used throughout this application may also include approximately the same time, i.e. within a few milliseconds or microseconds. Of course, the time difference, if any, will depend on the particular hardware and/or the calibration process. The set of images may be taken by two or more cameras at different angles, which provide a basis for the three-dimensional modeling of the object that the subject of the set of images.

In at least one embodiment, the processing module 102 may comprise specialized or general purpose computers comprising appropriate operating systems (Windows, Linux, OS X, Android) and software for the 3D modeling based on the set of images or stereophotogrammetry. Commercial software may include 3DF ZEPHYR, 4E SOFTWARE, DRONEMAPPER, MEMENTIFY, SMART3DCAPTURE, PIX4UAV, ARC3D, and other software known to those skilled in the art. The software may calculate the location of each pixel in 3D space by comparing the locations of common pixels across the set of images. A point cloud may then be generated after the pixels are analyzed. The user may approve the common pixels, and/or a 3D image is generated based on the common pixels detected.

In a preferred embodiment, the system 100 comprises a plurality of stereophotogrammetric units 110 communicably connected to the controller 101, whereby the controller 101 effects the sequential triggering of the stereophotogrammetric units 110 to increase the rate of capture or frames captured per second. In such an embodiment, the processing module 102 which may be connected to the controller 101 and/or the stereophotogrammetric units 110 may further be configured to generate a 4D image by linking together the 3D images generated for each set of images captured.

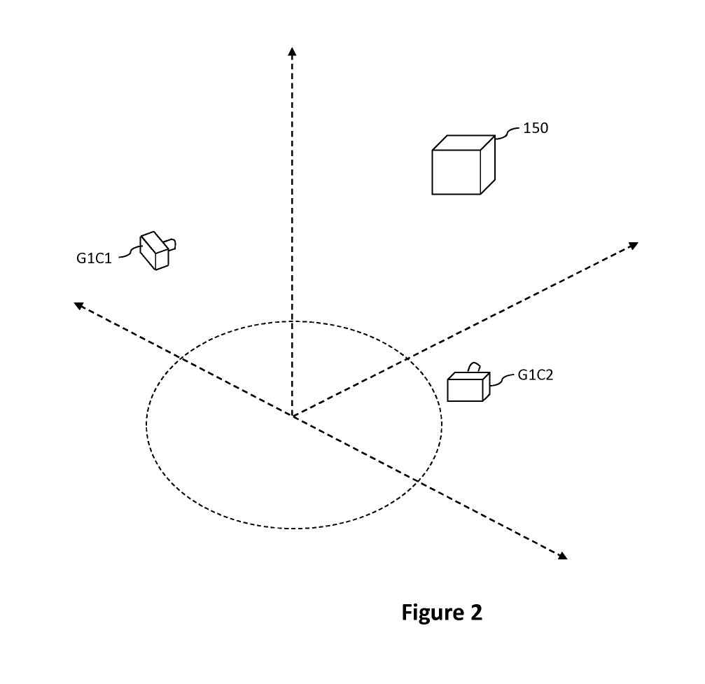

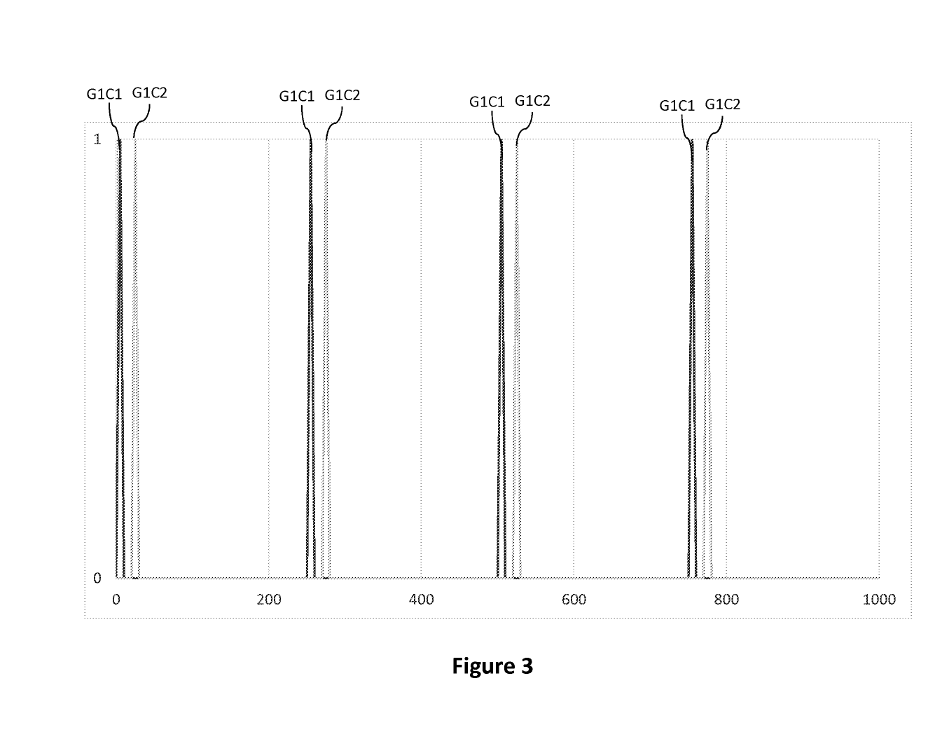

The benefit of such an embodiment is the increased throughput of capture of the sets of images, which is illustrated in FIGS. 2-5. As shown in FIG. 2, cameras G1C2 and G1C2 make up a single photogrammetric unit G1 configured to capture object 150. FIG. 3 illustrates the rate of capture, where 1 on the y-axis corresponds with the triggering of each camera. According to FIG. 3, four sets of images were captured within 1 second, due to the technical limitations of the cameras.

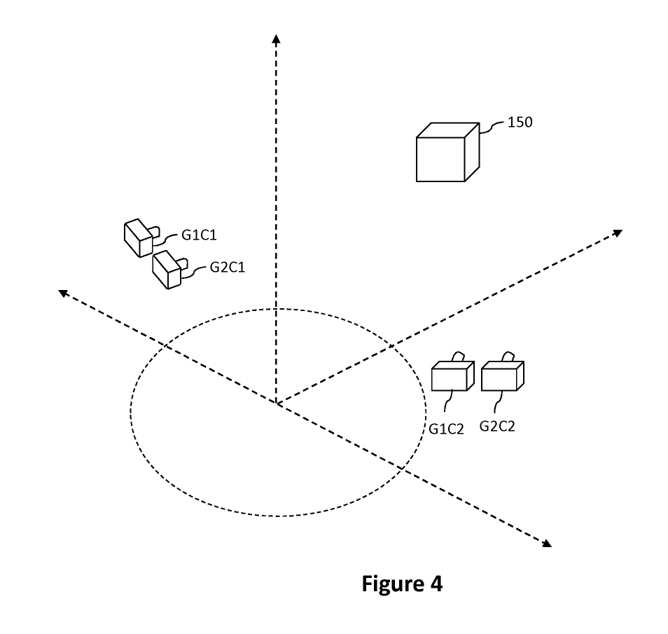

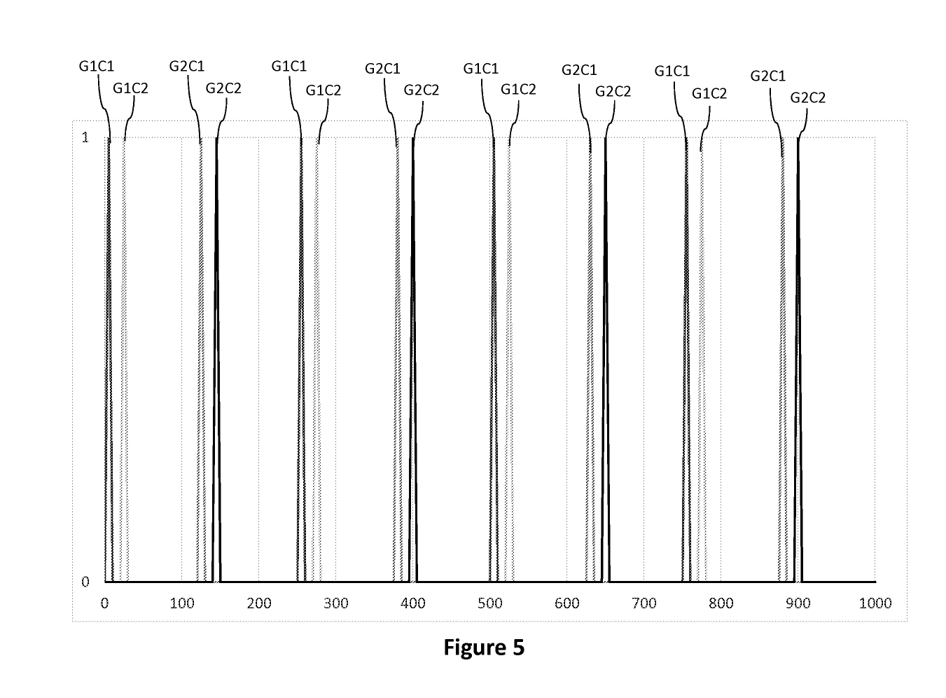

Moving to FIG. 4, two photogrammetric units G1 and G2 are now utilized to capture object 150. G1 comprises cameras G1C1 and G1C2, and G2 comprises cameras G2C1 and G2C2. Accordingly, by alternating the triggering of the two stereophotogrammetric units G1 and G2, throughput of image capture can be doubled, as shown in FIG. 5. The four frames per second of the system illustrated by in FIG. 2 is now doubled to eight frames per second, in the system of FIG. 4. By adding additional stereophotogrammetric groups to trigger in alternating sequence, the frames per second capture rate can be increased further. For example, if four stereophotogrammetric groups were used and triggered in alternating order, the frame rate would reach sixteen frames per second.

To accomplish this, the controller 101 may be configured to facilitate the sequential triggering of the plurality of stereophotogrammetric units 110, by transmitting each of a plurality of synchronized trigger signals to each of the plurality of stereophotogrammetric units 110 in a predetermined order at predetermined time intervals. The calibration of the synchronized trigger signals may be completed the same way as described above, for each stereophotogrammetric unit 110. The processing module 102, may further be configured to link together the 3D images, after the 3D modeling of each set of images, in order to create a 3D animation or a 4D image, using appropriate hardware and software.

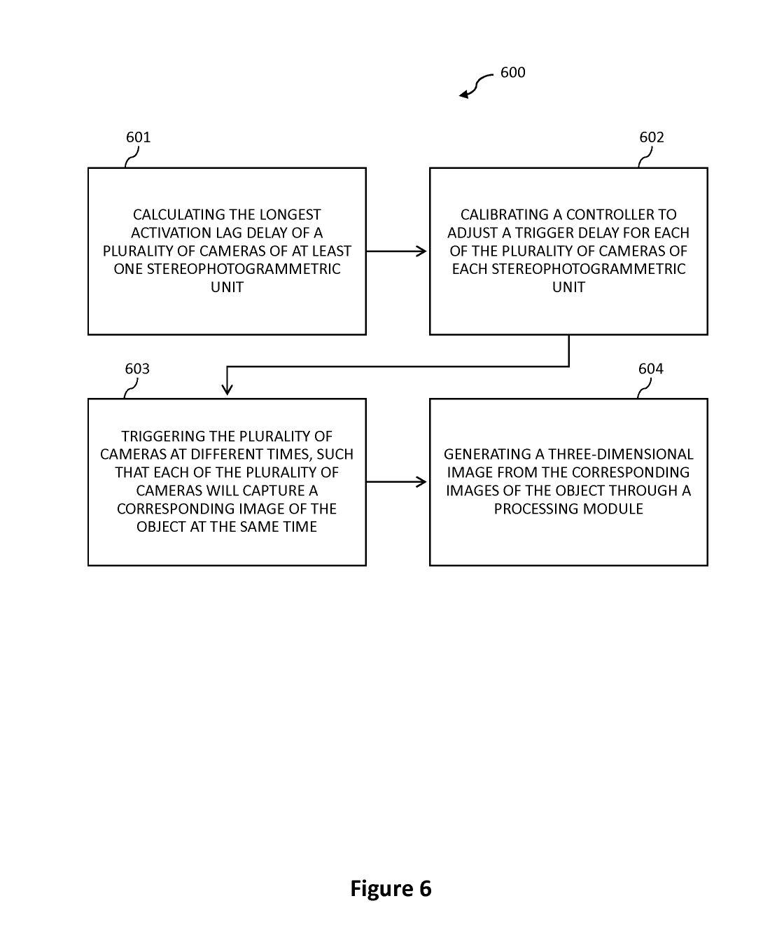

Further embodiments of the present invention include a stereophotogrammetric method for capturing three-dimensional images, in accordance to FIG. 6. The longest activation lag delay of a plurality of cameras of at least one stereophotogrammetric unit is first calculated, as in 601. A controller is then calibrated, as in 602, to adjust a trigger delay for each of the plurality of cameras of each stereophotogrammetric unit, such that the plurality of cameras will capture a corresponding image of an object at the same time. The plurality of cameras are then triggered at different times, as in 603, such that each of the plurality of cameras captures a corresponding image of the object at the same time as the other cameras. A three-dimensional image is finally generated, as in 604, from the corresponding images of the object through a processing module.

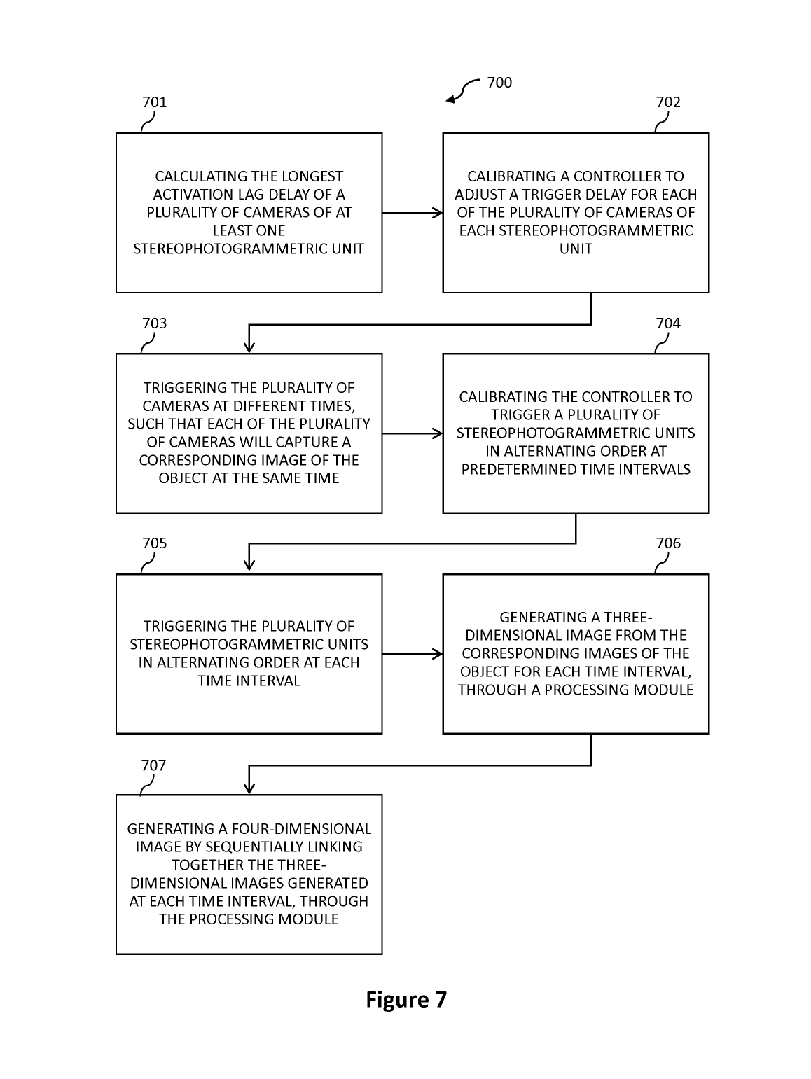

Another stereophotogrammetric method for capturing three-dimensional images is illustrated in FIG. 7. Similarly, the longest activation lag delay of a plurality of cameras of at least one stereophotogrammetric unit is first calculated, as in 701. A controller is then calibrated to adjust a trigger delay for each of the plurality of cameras of each stereophotogrammetric unit, as in 702. The plurality of cameras are triggered at different times, as in 703, such that each of the plurality of cameras will capture a corresponding image of the object at the same time as the other cameras. The controller is further calibrated to trigger a plurality of stereophotogrammetric units in alternating order at predetermined time intervals, as in 704. The plurality of stereophotogrammetric units are then triggered in alternating order, as in 705, at each time interval. A three-dimensional image is generated from the corresponding images of the object for each time interval, as in 706, through a processing module. Finally, a four-dimensional image is generated by sequentially linking together the three-dimensional images generated at each time interval, as in 707, through the processing module.

The components described in the above steps may comprise the same or similar components as those described for the system 100 of the present invention. Any of the above steps may be completed in sequential order in at least one embodiment, though they may be completed in any other order. In at least one embodiment, the above steps may be exclusively performed, but in other embodiments, one or more steps of the steps as described may be skipped.

Since many modifications, variations and changes in detail can be made to the described preferred embodiment of the invention, it is intended that all matters in the foregoing description and shown in the accompanying drawings be interpreted as illustrative and not in a limiting sense. Thus, the scope of the invention should be determined by the appended claims and their legal equivalents.

Now that the invention has been described,

What is claimed is:

1. A stereophotogrammetric system for capturing three-dimensional objects, said system comprising:
a stereophotogrammetric unit structured to capture a set of images of an object at different angles, said stereophotogrammetric unit comprises a plurality of cameras disposed in spaced-apart relation;
a controller communicably connected to said stereophotogrammetric unit, said controller configured to facilitate the simultaneous triggering of said plurality of cameras by transmitting a synchronized trigger signal to said stereophotogrammetric unit.
a processing module configured to generate a three-dimensional image from the set of images captured.

2. A stereophotogrammetric system as recited in claim 1 wherein said controller is further configured to minimize the activation lag difference between said plurality of cameras of said stereophotogrammetric unit.

3. A stereophotogrammetric system as recited in claim 1 wherein said synchronized trigger signal comprises a plurality of camera trigger signals, wherein each given camera signal is directed to the triggering of a given camera.

4. A stereophotogrammetric system as recited in claim 3 wherein said controller is further configured to delay the triggering of at least one camera by delaying at least one camera signal.

5. A stereophotogrammetric system as recited in claim 1 further comprising a calibration module configured to calculate the activation lag delay of each of said plurality of cameras.

6. A stereophotogrammetric system as recited in claim 5 wherein said calibration module is further configured to calculate a delay for each camera of a stereophotogrammetric unit, such that each of said plurality of cameras will capture a corresponding image of the object at the same time.

7. A stereophotogrammetric system for capturing three-dimensional objects, said system comprising:
a plurality of stereophotogrammetric units each structured to capture a set of images of an object at different angles, each of said plurality of stereophotogrammetric units comprising a plurality of cameras disposed in spaced-apart relation;
a controller communicably connected to said plurality of stereophotogrammetric units, said controller configured to facilitate the simultaneous triggering of said plurality of cameras, by transmitting a synchronized trigger signal to each of said plurality of stereophotogrammetric units;
said at least one controller further configured to facilitate the sequential triggering of said plurality of stereophotogrammetric units, by transmitting each of a plurality of synchronized trigger signals to each of said plurality of stereophotogrammetric units in a predetermined order at a predetermined time intervals; and
a processing module configured to generate a three-dimensional image from each set of images captured.

8. A stereophotogrammetric system as recited in claim 7 wherein said controller is further configured to minimize the activation lag difference between said plurality of cameras of each of said stereophotogrammetric unit.

9. A stereophotogrammetric system as recited in claim 7 wherein said synchronized trigger signal comprises a plurality of camera trigger signals, wherein each given camera signal is directed to the triggering of a given camera.

10. A stereophotogrammetric system as recited in claim 9 wherein said controller is further configured to delay the triggering of at least one camera by delaying at least one camera signal.

11. A stereophotogrammetric system as recited in claim 7 further comprising a calibration module configured to calculate the activation lag delay of each of said plurality of cameras.

12. A stereophotogrammetric system as recited in claim 11 wherein said calibration module is further configured to calculate a delay for each camera of a stereophotogrammetric unit, such that each camera will be triggered at a certain time in order to capture a corresponding image of the object at the same time across all cameras.

13. A stereophotogrammetric system as recited in claim 7 wherein said process module is further configured to generate a four dimensional image by linking together a plurality of the three-dimensional images in sequence.

14. A stereophotogrammetric method for capturing three-dimensional objects, the method comprising:
calculating the longest activation lag delay of a plurality of cameras of at least one stereophotogrammetric unit;
calibrating a controller to adjust a trigger delay for each of the plurality of cameras of each stereophotogrammetric unit; and
triggering the plurality of cameras at different times, such that each of the plurality cameras will capture a corresponding image of the object at the same time.

15. A stereophotogrammetric method as recited in claim 14 further comprising generating a three dimensional image from the corresponding images of the object through a processing module.

16. A stereophotogrammetric method as recited in claim 14 further comprising calibrating the controller to trigger a plurality of stereophotogrammetric units in alternating order at predetermined time intervals.

17. A stereophotogrammetric method as recited in claim 15 further comprising triggering the plurality of stereophotogrammetric units in alternating order at each time interval.

18. A stereophotogrammetric method as recited in claim 17 further comprising generating a three-dimensional image from the corresponding images of the object for each time interval, through a processing module.

19. A stereophotogrammetric method as recited in claim 17 further comprising generating a four-dimensional image by sequentially linking together the three-dimensional images generated at each time interval, through the processing module.
